(19) United States
(12) Patent Application Publication
(10) Pub. No.: US 2026/0125034 A1
(43) Pub. Date: May 7, 2026

(54) METHOD AND DEVICE FOR OPERATING BRAKES OF VEHICLE

(71) Applicants: Hyundai Motor Company, Seoul (KR); Kia Corporation, Seoul (KR)

(72) Inventors: Hyunseon CHAE, Hwaseong-Si (KR); Sae Yong JANG, Hwaseong-Si (KR); Minju KIM, Hwaseong-Si (KR)

(21) Appl. No.: 19/371,698

(22) Filed: Oct. 28, 2025

(30) Foreign Application Priority Data
Nov. 4, 2024 (KR) 10-2024-0154055

(51) Int. Cl. B60T 7/16

(52) U.S. Cl. CPC B60T 7/16; B60T 2210/30; B60T 2220/00; B60T 2230/02; B60T 2250/02; B60T 2250/04

(57) ABSTRACT

A method for operating brakes of a vehicle includes: transmitting vehicle location information acquired from a location detection device mounted on the vehicle to a remote server, receiving first remote data on whether the vehicle is located within a goods delivery zone that is calculated based on the location information from the remote server, switching a vehicle operation mode to a brake automatic operation mode if a value of the first remote data is determined to indicate that the vehicle is located within the goods delivery zone; determining whether a predetermined first condition is satisfied in the automatic operation mode; and transmitting an instruction to a vehicle integration controller mounted on the vehicle to operate the brakes of the vehicle in a first manner if the first condition is determined to be satisfied. A device for operating brakes of the vehicle may perform the method.

### CROSS-REFERENCE TO RELATED APPLICATION

This application claims priority to and the benefit of Korean Patent Application No. 10-2024-0154055 filed in the Korean Intellectual Property Office on Nov. 4, 2024, the entire contents of which are incorporated herein by reference.

### TECHNICAL FIELD

The present disclosure relates to a method and a device for operating brakes of a vehicle.

### BACKGROUND

In order to deliver goods, a delivery driver, for example, may perform a process of getting off a vehicle and delivering the goods. It may be required (e.g., legally) and/or safer for the delivery driver to turn off an engine if getting off the vehicle (e.g., to prevent an accident, prevent theft of the vehicle, etc.). However, the delivery driver may get off the vehicle without turning off the engine (e.g., for convenience in light of frequently having to stop and get in and out of the vehicle). Skipping turning off the engine may increase work efficiency by allowing faster delivery and/or shorter work hours. However, leaving a vehicle on unattended may lead to serious safety issues and economic losses.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

Systems, apparatuses, and methods are described for operating brakes of a vehicle. A method for operating brakes of a vehicle may be performed by a computing device, of the vehicle, comprising a processor and a communication interface. The method may comprise transmitting, by the processor and via the communication interface to a remote server, vehicle location information acquired from a location sensor mounted on the vehicle, wherein the vehicle location information indicates a location of the vehicle; receiving, by the processor from the remote server via the communication interface, first remote data indicating whether the vehicle is located within a goods delivery zone, wherein the first remote data is based on the vehicle location information; setting, by the processor based on the first remote data indicating that the vehicle is located within the goods delivery zone, a vehicle operation mode to a brake automatic operation mode; determining, by the processor, whether a first condition, for operating the brakes of the vehicle in the brake automatic operation mode, is satisfied; and transmitting, by the processor based on the first condition being satisfied, an instruction to a vehicle integration controller mounted on the vehicle, wherein the instruction is configured to cause the vehicle integration controller to operate the brakes of the vehicle in a first manner that is associated with the brake automatic operation mode.

A device for operating brakes of a vehicle may comprise: at least one processor; a communication interface; and a memory storing at least one instruction that, when executed by the at least one processor, causes the device to: transmit, via the communication interface to a remote server, vehicle location information acquired from a location sensor mounted on the vehicle, wherein the vehicle location information indicates a location of the vehicle; receive, from the remote server via the communication interface, first remote data indicating whether the vehicle is located within a goods delivery zone, wherein the first remote data is based on the vehicle location information; set, based on the first remote data indicating that the vehicle is located within the goods delivery zone, a vehicle operation mode to a brake automatic operation mode; determine whether a first condition, for operating the brakes of the vehicle in the automatic operation mode, is satisfied; and transmit, based on the first condition being satisfied, a second instruction to a vehicle integration controller mounted on the vehicle, wherein the second instruction is configured to cause the vehicle integration controller to operate the brakes of the vehicle in a first manner associated with the brake automatic operation mode.

A non-transitory computer-readable recording medium may store instructions that, when executed, cause a computing device implemented in a vehicle to: transmit, via a communication interface of the computing device of the vehicle and to a remote sever, vehicle location information acquired from a location sensor mounted on the vehicle, wherein the vehicle location information indicates a location of the vehicle; receive, from the remote sever via the communication interface, first remote data indicating whether the vehicle is located within a goods delivery zone, wherein first remote data zone is based on the vehicle location information; set, based on the first remote data indicating that the vehicle is located within the goods delivery zone, a vehicle operation mode to a brake automatic operation mode; determine whether a first condition, for operating brakes of the vehicle in the brake automatic operation mode, is satisfied; and transmit, based on the first condition being satisfied, a second instruction to a vehicle integration controller mounted on the vehicle, wherein the second instruction is configured to cause the vehicle integration controller to operate the brakes of the vehicle in a first manner associated with the brake automatic operation mode.

These and other features and advantages are described in greater detail below.

### BRIEF DESCRIPTION OF THE DRAWINGS

FIG. 1 is a view for describing a device for operating brakes of a vehicle according to an example.

FIG. 2 is flowchart of a method for operating brakes of a vehicle according to an example.

FIG. 3 is flowchart of a method for operating brakes of a vehicle according to an example.

FIG. 4 is flowchart of a method for operating brakes of a vehicle according to an example.

FIG. 5 is flowchart of a method for operating brakes of a vehicle according to an example.

FIG. 6 is flowchart of a method for operating brakes of a vehicle according to an example.

FIG. 7 is flowchart of a method for operating brakes of a vehicle according to an example.

FIG. 8 is a view for describing a computing device according to an example.

### DETAILED DESCRIPTION OF THE EXAMPLES

Hereinafter, examples of the present disclosure are described in detail with reference to the accompanying drawings so that those skilled in the art to which the present disclosure pertains may easily practice the present disclosure. However, the present disclosure may be implemented in various different forms and is not constrained to the examples provided herein. In addition, in the drawings, portions unrelated to the description are omitted to clearly describe the present disclosure, and similar portions are denoted by similar reference numerals throughout the specification.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B. “One or more of” is synonymous with “at least one of” herein.

Through the specification and claims, unless explicitly described otherwise, terms such as “including,” “having,” “comprising,” and the like are intended to mean the inclusion/presence of a characteristic (e.g., a function, operation, component, etc.) and do not exclude the presence of another characteristic.

Terms including ordinal numbers such as “first” and “second” may be used to describe various components. However, these components are not constrained to these terms. These terms are used only to distinguish one component and another component from each other.

Unless otherwise defined, the terms used herein, including technical or scientific terms, may have meanings generally understood by those skilled in the art to which the present disclosure belongs. A singular expression used herein may include the meaning of the plural unless otherwise stated in the context, which also applies to the singular expression described in the claims.

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

In the present disclosure, the “module” or “unit” or one or more controllers (e.g., a control device, a control unit, etc.) may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like.

A controller may include a communication device for communicating with other controllers or a sensor to control one or more functions and/or operations in charge, a memory storing an operation system, a logic command, and input/output information, and/or one or more processors performing determination, calculation, and decision necessary for controlling the function in charge. A controller may include, for example, a processor, a central processing unit (CPU), a microchip, a logic, an application-specific integrated circuit (ASIC), memory, etc. A controller may manipulate and/or control other components in the system (e.g., vehicle).

The expression “based on” as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to”, “with the ability to”, “modified to”, “made to”, “to be able to”, etc. This expression is not limited to the meaning of “specially designed in hardware to”. For example, a processor configured to perform a specific operation may refer to a generic purpose processor capable of performing the specific operation by executing software, or to a special purpose computer structured through programming to perform the specific operation.

At least some components or functions of a method and a device for operating brakes of a vehicle that automatically operate the brakes of the vehicle (e.g., in consideration of a goods delivery situation) according to the examples described herein may be implemented as a program and/or software. The program or software may be stored on a computer-readable recording medium or storage medium.

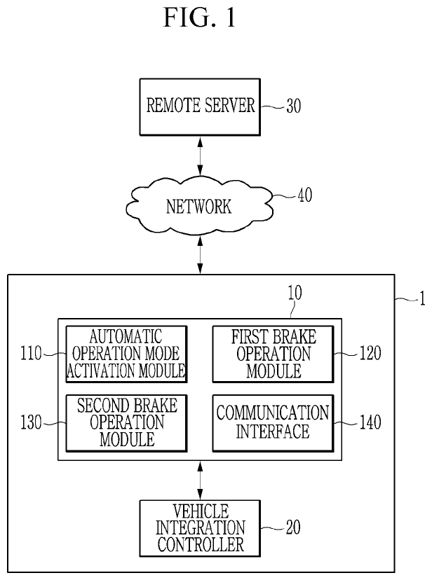

FIG. 1 is a view for describing the device for operating brakes of a vehicle according to an example.

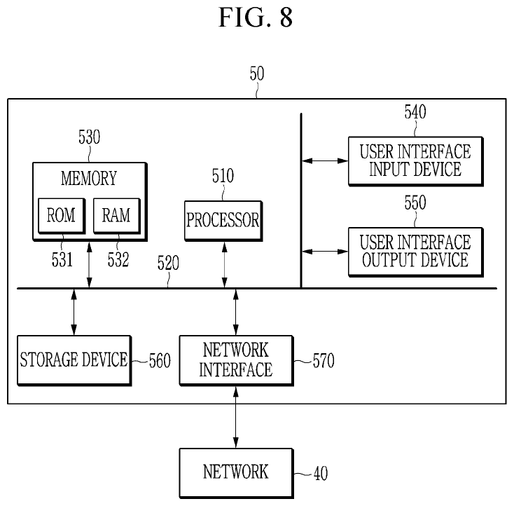

Referring to FIG. 1, a device 10 for operating brakes of a vehicle according to an example may execute a program code and/or an instruction loaded on at least one memory device via at least one processor (e.g., of the device 10). For example, the device 10 for operating brakes of a vehicle may be implemented as a computing device 50, such as described with reference to FIG. 8. Here, the device 10 (e.g., implemented as and/or comprising one or more computing devices 50) may be implemented in a vehicle 1, for example, as a controller mounted on the vehicle 1. The at least one processor may correspond to a processor 510 of the computing device 50, and the at least one memory device may correspond to a memory 520 of the computing device 50. The program code and/or the instruction executed by at least one processor may automatically operate the brakes of the vehicle in consideration of a goods delivery situation. Herein, a term “module” is used to logically distinguish functions performed by the program code and/or the instruction and describe the same.

The device 10 for operating brakes of a vehicle may be implemented within the vehicle 1. The device 10 for operating brakes of a vehicle may exchange data with a vehicle integration controller 20 implemented together within the vehicle 1 via an internal network. In some examples, the internal network may include a controller area network (CAN), a local interconnect network (LIN), Automotive Ethernet, or the like. The vehicle integration controller 20 may be a device that comprehensively manages and controls various systems installed in the vehicle 1. The device 10 may be integral with the vehicle integration controller 20.

The vehicle integration controller 20 may include, for example, an integrated central control unit (ICU), a vehicle control unit (VCU), a cluster (CLU), an integrated electronic brake (IEB), an inertial measurement unit (IMU), and/or a cargo control unit. The vehicle integration controller 20 may manage and/or control each of the ICU, VCU, CLU, IEB, IMU, and/or cargo control unit in an integrated (e.g., coordinated) manner. The ICU may have control functions and/or gateway functions, such as those for a lamp and/or a door lock. For example, the ICU may detect a driver getting-on/off state and/or open/close states of a door of the vehicle 1. The VCU may collect and process real-time data from various sensors and systems within the vehicle 1. For example, the VCU may be linked (e.g., in communication with, wired or wireless) to a powertrain of the vehicle 1 to check a real-time vehicle gear state, (e.g., current gear position, such as park (P), reverse (R), neutral (N), or drive (D)). Also, or alternatively, the VCU may be linked to the IMU (e.g., to check an angle (tilt) at which the vehicle 1 is tilted). The CLU may have a function of informing (e.g., detecting and/or a vehicle driving state and/or vehicle information. The CLU may detect (e.g., receive a measurement indicating) and/or output (e.g., to a user), for example, a vehicle speed (e.g., receive the vehicle speed from a speedometer or other speed sensor, and output the vehicle speed). For example, the CLU may comprise an interface such as a panel to show information about operation of the vehicle, such as one or more gauges and/or warning lights (e.g., speedometer, odometer, mileage, fuel level indicator, etc.). The IEB may electronically integrate and/or control a brake system of the vehicle 1. In particular, the IEB may receive an instruction from the device 10 for operating brakes of a vehicle to operate the brakes in a designated manner. The IEB may execute the instruction, which may cause the IEB to control, based on the designated manner, a brake operation. The IMU may detect and/or track a movement of the vehicle 1, for example, by measuring the acceleration and/or angular velocity of the vehicle 1. The cargo control unit may manage and/or control a loading space of the vehicle 1, monitor the loading space, and/or measure and/or detect the weight and/or movement of loaded cargo.

The device 10 for operating brakes of a vehicle may exchange data with a remote server 30 via a network 40 The remote server 30 may comprise a server owned and/or serviced by a transportation company. For example, the vehicle 1 may be a goods delivery vehicle and communicate with the remote server 30 to receive various information, such as a goods delivery route, a goods delivery schedule, and/or a goods delivery stage. The vehicle 1 may provide the remote server 30 with various information on a goods delivery state, a state of the vehicle 1, and the like. The network 40 may include a wireless network, which may be implemented, for example, as a cellular network or a WiFi network.

The device 10 for operating brakes of a vehicle may include an automatic operation mode activation module 110, a first brake operation module 120, a second brake operation module 130, and a communication interface 140.

The automatic operation mode activation module 110 may activate and/or deactivate a brake automatic operation mode. For example, the automatic operation mode activation module 110 may switch a vehicle operation mode from a normal mode to the brake automatic operation mode to activate the brake automatic operation mode. The brake automatic operation mode may be a mode in which the brakes of the vehicle are automatically operated (e.g., in consideration of/based on the goods delivery situation). The normal mode may be a mode in which the brakes of the vehicle are controlled and operated by the driver (e.g., without considering/independent of the goods delivery situation).

The automatic operation mode activation module 110 may transmit location information of the vehicle 1 to the remote server 30 via the communication interface 140. The location information may be is acquired from/by a location detection device (e.g., location sensor) mounted on the vehicle 1. In some examples, the location detection device may include a global positioning system (GPS) device, but a method of acquiring the location information is not limited to using the GPS device. The location information may be acquired, for example, via the location information shared from another vehicle (e.g., via Vehicle-to-Everything (V2X) communication), and/or location information shared by another server/source (e.g., cell towers, WiFi, radio beacons), an inertial navigation system (INS), etc. The automatic operation mode activation module 110 may receive first remote data from the remote server 30 in response to the location information of the vehicle 1. The first remote data may be calculated/determined based on the location information of the vehicle 1. The first remote data may include a value indicating whether the vehicle 1 is located within a goods delivery zone.

The goods delivery zone may indicate a zone where the driver gets off the vehicle without turning off an engine to deliver goods. The goods delivery zone may be designated in a map managed by the remote server 30. For example, the remote server 30 may manage the map including the goods delivery zone. The map may include a plurality of goods delivery zones that are designed differently for each transportation company that provides a transportation and/or delivery service.

The remote server 30 may compare the location information of the vehicle 1 (e.g., the location information received from the automatic operation mode activation module 110) with the map managed by the remote server 30 (e.g., in which the goods delivery zone is included/designed). If a location of the vehicle 1 is determined to be within the goods delivery zone on the map, the first remote data may be determined to be a value indicating that the vehicle 1 is located within the goods delivery zone. If the location of the vehicle 1 is determined not to be within the goods delivery zone on the map, the first remote data may be determined to be a value indicating that the vehicle 1 is not located within the goods delivery zone.

The automatic operation mode activation module 110 may switch an operation mode of the vehicle 1 to the brake automatic operation mode (or “automatic operation mode”) if the value of the first remote data includes the value indicating that the vehicle 1 is located within the goods delivery zone.

Based on the operation mode being the automatic operation mode, first brake operation module 120 may determine whether a predetermined first condition is satisfied. The first brake operation module 120 may transmit an instruction to the vehicle integration controller 20 to operate the brakes of the vehicle 1 in a first manner if the first condition is determined to be satisfied. The vehicle integration controller 20 that receives the corresponding instruction may control the brake operation in the first manner. The first condition may apply when (e.g., only when) the automatic operation mode is being applied. The first condition may not trigger/cause operating the brakes in the first manner if the operation mode of the vehicle 1 is not the automatic operation mode. The first condition may comprise, for example, the driver being determined to be out of the vehicle and a door (e.g., a cargo door) being determined to be open. The driver may be determined to be out of the vehicle based on information received from one or more sensors, such as information from a weight sensor of the driver's seat, image information from a camera (e.g., an image and/or object recognition results of an image from a camera of the vehicle indicating the driver is not in the driver's seat and/or out of the vehicle), information from a driver's side door sensor indicating the driver's side door was opened from the inside, etc. The first condition may also, or alternatively, comprise the vehicle not being in a park gear (e.g., being in a neutral gear, a drive gear, a reverse gear, etc.) for at least a threshold amount of time (e.g., at least 10 minutes, at least 5 minutes, at least 2 minutes, at least 1 minute, etc.).

In some examples, the first manner may include an auto hold. The auto hold may comprise a function of maintaining the vehicle in a stopped state even if a brake pedal of the vehicle is not being pressed when/if the vehicle is stopped. The auto hold function may be activated when/if a certain condition is satisfied, such as all the doors of the vehicle being closed and/or a driver seat belt being fastened. On a general driving road, the driver may have no difficulty in using the auto hold function. However, in a situation such as the goods delivery situation where the driver frequently gets on and off the vehicle and a cargo door is opened, the driver may have difficulty in actually using an existing auto hold function. To improve this issue, based on the operation mode being the automatic operation mode, the first brake operation module 120 may automatically maintain the vehicle 1 in the stopped state (e.g., apply the brakes) based on satisfaction of the first condition. the first brake operation module 120 may (e.g., directly) transmit the instruction for activating the auto hold function to the vehicle integration controller 20 based on the first condition being satisfied. If the vehicle 1 is stopped in a situation determined as the goods delivery situation (e.g., driver out of car, cargo door open), the first brake operation module 120 may automatically apply the brakes, thereby increasing the convenience of work and efficiency of the driver, for example, the delivery driver, while preventing accidents.

The first condition may include a condition for automatically applying the brakes of the vehicle 1 in a first manner if/when the driver is out of the vehicle and/or the cargo door is opened. The first brake operation module 120 may use data received from the remote server 30 and/or data collected from one or more sensors of the vehicle to determine whether the first condition is satisfied.

In detail, the first brake operation module 120 may receive second remote data and/or third remote data from the remote server 30 via the communication interface 140. The second remote data may comprise data indicating an allowable cargo weight associated with a slope/gradient (e.g., a cargo weight allowed on the slope/gradient). The third remote data may comprise a factor for slope angle correction. Values of the second remote data and the third remote data may be determined by the remote server 30 and/or transmitted to the first brake operation module 120.

The first brake operation module 120 may receive first local data, second local data, third local data, and/or fourth local data from the vehicle integration controller 20 (e.g., via the internal network of the vehicle 1). The first local data may be data indicating the driver getting-on/off state (e.g., a driver getting-on state or a driver getting off state), and the second local data may be data indicating the open/close state of the door installed in the vehicle cargo. The third local data may be data indicating the weight of the cargo loaded on the vehicle, and/or the fourth local data may be data indicating the tilt angle of the vehicle. In some examples, the first brake operation module 120 may receive the first local data and the second local data from the ICU of the vehicle integration controller 20. The first brake operation module 120 may receive the third local data from the cargo control unit of the vehicle integration controller 20. The first brake operation module 120 may receive the fourth local data from the VCU of the vehicle integration controller 20. The first brake operation module 120 may also, or alternatively, receive gradient data based on location information of the vehicle (e.g., from a corresponding topological map, GPS topological data, etc.).

The first brake operation module 120 may determine/calculate a slope reference angle for determining whether the slope is present based on the second remote data, the third remote data, and/or the third local data.

In some examples, the first brake operation module 120 may determine/calculate the slope reference angle based on the following Equation:

$$A = S * M / m * a \qquad ( Equation )$$

where, A indicates the slope reference angle, S indicates the predetermined slope standard angle (e.g., ‘10’), M indicates the allowable cargo weight that is allowed on the slope determined based on the second remote data, m indicates the weight of the cargo loaded on the vehicle that is determined based on the third local data, and a indicates the factor for the slope angle correction determined based on the third remote data.

In some examples, as the factor for the slope angle correction, the third remote data may be set to have a lower value when/if a safety requirement to be achieved is higher, and a higher value when/if the safety requirement is lower. For example, the third remote data may be set to ‘50%’ if the safety requirement is high, and to ‘200%’ if the safety requirement is low. The safety requirement may be input, e.g., via a user database and/or set higher based on road/weather/vehicle information that may be associated with increased slipping (e.g., gravel road, rainy, snowy weather, a low weight car, old wheels, maintenance alerts, etc.).

In some examples, the third remote data may be set to have a different value depending on the weather in the goods delivery zone where the vehicle 1 is located. For example, the third remote data may be set to ‘50%’ if the weather in the goods delivery zone is rainy or snowy, and to ‘100%’ if it is other weather (e.g., sunny, low wind).

The first brake operation module 120 may determine that the first condition is satisfied, for example, if a value of the first local data indicates a driver getting-off state, a value of the second local data indicates the door open state, and/or a value of the fourth local data indicates a slope angle less than or equal to the slope reference angle. Based on the first condition being determined to be satisfied while the vehicle 1 is in the automatic operation mode, the first brake operation module 120 may transmit the instruction to the vehicle integration controller 20 to operate the brakes of the vehicle 1 in the first manner. The vehicle integration controller 20 that receives the corresponding instruction may control the brake operation in the first manner.

In some examples, the first condition may include a condition for automatically operating the brakes of the vehicle 1 in the first manner if the driver is in the getting-on state and the vehicle gear state of the vehicle 1 is not in the P position and is stopped for a predetermined time period. The first brake operation module 120 may use the data collected via one or more sensors of the vehicle to determine whether the first condition is satisfied.

The first brake operation module 120 may receive the first local data, fifth local data, and sixth local data (e.g., via the internal network of the vehicle 1). The first local data may be data indicating the driver getting-on/off state, and the fifth local data may be data indicating the speed of the vehicle 1. The sixth local data may be data indicating the gear state of the vehicle 1. In some examples, the first brake operation module 120 may receive the first local data from the ICU of the vehicle integration controller 20 and the fifth local data from the CLU of the vehicle integration controller 20. In addition, the first brake operation module 120 may receive the sixth local data from the VCU of the vehicle integration controller 20.

The first brake operation module 120 may determine that the first condition is satisfied, for example, if the value of the first local data indicates the driver getting-on state, a value of the fifth local data is 0, a value of the sixth local data indicates the vehicle gear state other than the P position, and the values of the first local data, the fifth local data, and the sixth local data are maintained to be the same for the predetermined time period (e.g., 10 minutes). The first brake operation module 120 may transmit the instruction to the vehicle integration controller 20 to operate the brakes of the vehicle 1 in the first manner The vehicle integration controller 20 that receives the corresponding instruction may control the brake operation in the first manner.

Based on the operation mode being the automatic operation mode, the second brake operation module 130 may also, or alternatively, determine whether a predetermined second condition is satisfied. The second brake operation module 130 may transmit an instruction to the vehicle integration controller 20 to operate the brakes of the vehicle 1 in a second manner if the second condition is determined to be satisfied. The vehicle integration controller 20 that receives the corresponding instruction may control the brake operation in the second manner. The second condition may apply when (e.g., only when) the automatic operation mode is being applied. The second condition may not trigger/cause operating the brakes in the second manner if the operation mode of the vehicle 1 is not the automatic operation mode. The second condition may comprise, for example, the driver being determined to be out of the vehicle/getting out of the vehicle while the vehicle is on a slope. The driver may be determined to be out of/getting out of the vehicle based on information received from one or more sensors, such as information from a weight sensor of the driver's seat, image information from a camera (e.g., an image and/or object recognition results of an image from a camera of the vehicle indicating the driver is not in the driver's seat and/or out of the vehicle), information from a driver's side door sensor indicating the driver's side door was opened from the inside, etc. The second condition may also, or alternatively, comprise detected movement/rolling of the vehicle while the brakes are being operated in the first manner (e.g., autohold).

In some examples, the second manner may include an electronic parking brake (EPB) method. The EPB may replace/function as a mechanical parking brake, and/or may allow an electronic control device to operate the brake system to immobilize the vehicle (e.g., based on the driver pressing a button, for example). The EPB may also, or alternatively, be activated automatically (e.g., if/when the vehicle is stopped and/or the engine is turned off). The second brake operation module 130 may automatically maintain the vehicle 1 in a parking brake state under the second condition by directly transmitting, if/when the second condition is satisfied, the instruction to activate the EPB to the vehicle integration controller 20. If/when the vehicle 1 is stopped in a situation determined as a goods delivery situation (e.g., the first condition is satisfied) and/or determined as requiring the parking brake (e.g., the second condition is satisfied), the second brake operation module 130 may automatically apply the parking brake, thereby increasing the convenience of work and efficiency of the driver (for example, the delivery driver) while preventing accidents.

In some examples, the second condition may include a condition for automatically operating the parking brake of the vehicle 1 in the second manner when/if the driver is in the getting-off state on a slope. The second brake operation module 130 may use the data received from the remote server 30 and/or the data collected within the vehicle 1 (e.g., one or more sensors of the vehicle) to determine whether the second condition is satisfied.

The second brake operation module 130 may receive the second remote data and the third remote data from the remote server 30 via the communication interface 140. The second remote data may be the data indicating the allowable cargo weight that is allowed on the slope. The third remote data may be the factor for the slope angle correction. The values of the second remote data and the third remote data may be determined by the remote server 30 and transmitted to the second brake operation module 130.

The second brake operation module 130 may receive the first local data, the third local data, and the fourth local data from the vehicle integration controller 20 (e.g., via the internal network of the vehicle 1). The first local data may comprise the data indicating the driver getting-on state, the third local data may comprise the data indicating the weight of the cargo loaded on the vehicle, and the fourth local data may comprise the data indicating the tilt angle of the vehicle. In some examples, the second brake operation module 130 may receive the first local data from the ICU of the vehicle integration controller 20 and the third local data from the cargo control unit of the vehicle integration controller 20. In addition, the second brake operation module 130 may receive the fourth local data from the VCU of the vehicle integration controller 20.

The second brake operation module 130 may calculate the slope reference angle for determining whether the slope is present based on the second remote data, the third remote data, and the third local data.

In some examples, the second brake operation module 130 may calculate the slope reference angle based on the following Equation.

$$A = S * M / m * a \qquad ( Equation )$$

where, A indicates the slope reference angle, S indicates the predetermined slope standard angle (e.g., ‘10’), M indicates the allowable cargo weight that is allowed on the slope determined based on the second remote data, m indicates the weight of the cargo loaded on the vehicle that is determined based on the third local data, and a indicates the factor for the slope angle correction determined based on the third remote data.

As the factor for the slope angle correction, the third remote data may be set to have the lower value when the safety requirement to be achieved is higher, and the higher value when the safety requirement is lower. For example, the third remote data may be set to ‘50%’ if the safety requirement is high, and to ‘200%’ if the safety requirement is low.

In some examples, the third remote data may be set to have the different value depending on the weather in the goods delivery zone where the vehicle 1 is located. For example, the third remote data may be set to ‘50%’ if the weather in the goods delivery zone is rainy or snowy, and to ‘100%’ if it is other weather.

The second brake operation module 130 may determine that the second condition is satisfied if the value of the first local data indicates the driver getting-off state and the value of the fourth local data is greater than the slope reference angle. The second brake operation module 130 may transmit, based on the second condition being satisfied, the instruction to the vehicle integration controller 20 to operate the brakes of the vehicle 1 in the second manner The vehicle integration controller 20 that receives the corresponding instruction may control the brake operation in the second manner.

In some examples, the second condition may include a condition for automatically operating the parking brake of the vehicle 1 in the second manner if the vehicle 1 in the braking state in the first manner (e.g., auto hold state) is detected to roll. The second brake operation module 130 may use the data collected within the vehicle to determine whether the second condition is satisfied.

In detail, the second brake operation module 130 may receive seventh local data (e.g., via the internal network of the vehicle 1). The seventh local data may be data indicating the angular velocity of the vehicle. In some examples, the second brake operation module 130 may receive the seventh local data from the IMU of the vehicle integration controller 20.

The second brake operation module 130 may determine that the second condition is satisfied if the brakes of the vehicle 1 are operated in the first manner and a value of the seventh local data is other than 0. The second brake operation module 130 may transmit, based on the second condition being satisfied, the instruction to the vehicle integration controller 20 to operate the brakes of the vehicle 1 in the second manner. The vehicle integration controller 20 that receives the corresponding instruction may control the brake operation in the second manner.

According to this example, convenience of a driver work may be increased while effectively preventing the accidents that may occur during the delivery by identifying a vehicle location in real time and controlling the brake operation based on a specific situation when the vehicle is stopped in the goods delivery zone.

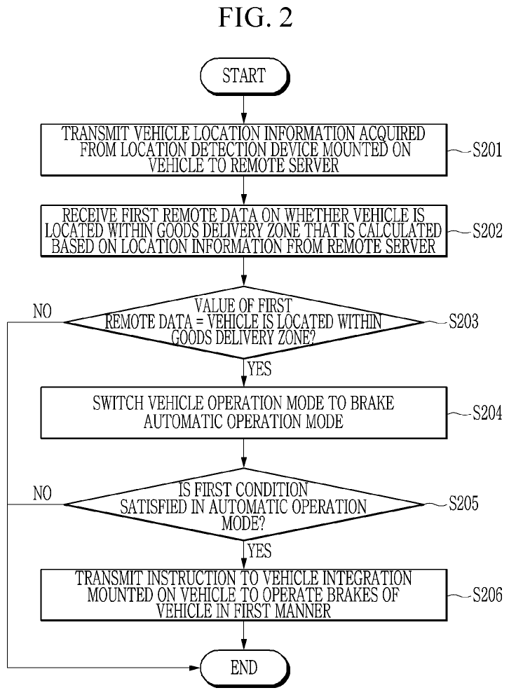

FIG. 2 is flowchart of a method for operating brakes of a vehicle according to an example.

Referring to FIG. 2, the method for operating brakes of a vehicle according to an example includes: transmitting the vehicle location information acquired from the location detection device mounted on the vehicle to the remote server (S201); receiving the first remote data, calculated based on the location information from the remote server, indicating whether the vehicle is located within the goods delivery zone (S202); and determining whether the value of the first remote data indicates that the vehicle is located within the goods delivery zone (S203).

The method may include switching/setting/maintaining the vehicle operation mode to the brake automatic operation mode (S204) if the value of the first remote data is determined to indicate that the vehicle is located within the goods delivery zone (Yes in S203); and determining, based on the vehicle operation mode being the brake automatic operation mode, whether the first condition is satisfied in the automatic operation mode (S205).

The method may include transmitting the instruction to the vehicle integration controller mounted on the vehicle to operate the brakes of the vehicle in the first manner (S206) if the automatic operation mode is determined to satisfy the first condition (Yes in S205).

If the vehicle is determined not to be in the goods delivery zone (No in S203), the vehicle operation mode may be set to/maintained as/switched to a normal operation mode and/or the method may end and/or return to start. If the first condition is not satisfied in brake automatic operation mode (No in S205), the method may end and/or the method may return to start.

For more detailed information on the method, descriptions of examples included in this specification may be referred to, and its redundant description is thus omitted.

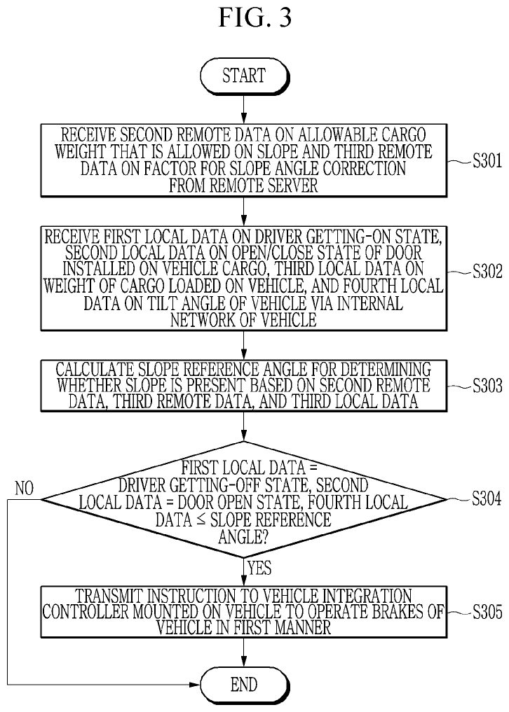

FIG. 3 is flowchart of a method for operating brakes of a vehicle according to an example.

Referring to FIG. 3, the method for operating brakes of a vehicle according to an example includes: receiving the second remote data indicating the allowable cargo weight that is allowed on the slope and the third remote data indicating the factor for the slope angle correction from the remote server (S301); receiving the first local data indicating the driver getting-on/off state, the second local data indicating the open/close state of the door installed on the vehicle cargo, the third local data indicating the weight of the cargo loaded on the vehicle, and the fourth local data indicating the tilt angle of the vehicle via the internal network of the vehicle (S302); calculating/determining the slope reference angle for determining whether the slope is present based on the second remote data, the third remote data, and the third local data (S303); and determining whether the value of the first local data indicates the driver getting-off state, the value of the second local data indicates the door open state, and the value of the fourth local data indicates a slope equal to or less than the slope reference angle (S304).

The method may include transmitting the instruction to the vehicle integration controller mounted on the vehicle to operate the brakes of the vehicle in the first manner (S305) if the value of the first local data indicates the driver getting-off state, the value of the second local data indicates the door open state, and the value of the fourth local data are determined to the slope reference angle or less (Yes in S304). If the value of the first local data does not indicate the driver getting-off state, the value of the second local data does not indicate the door open state, or the value of the fourth local data indicates a slope greater than the slope reference angle (No In S304), the method may end and/or return to stop.

For more detailed information on the method, descriptions of examples included in this specification may be referred to, and its redundant description is thus omitted.

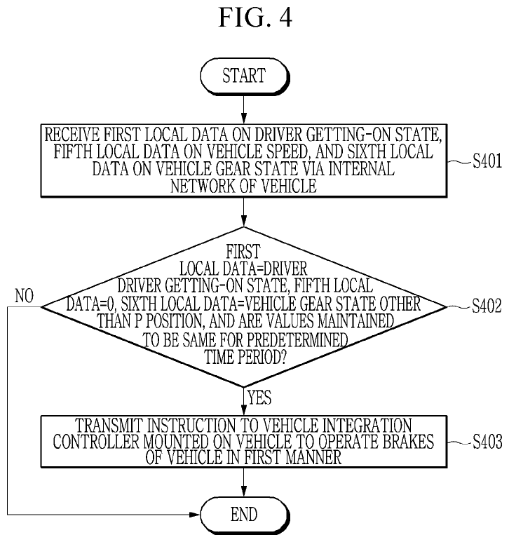

FIG. 4 is flowchart of a method for operating brakes of a vehicle according to an example.

Referring to FIG. 4, the method for operating brakes of a vehicle according to an example includes: receiving the first local data indicating the driver getting-on/off state, the fifth local data indicating the vehicle speed, and the sixth local data indicating the vehicle gear state via the internal network of the vehicle (S401); and determining whether the value of the first local data indicates the driver getting-on state, the value of the fifth local data is 0, the value of the sixth local data indicates the vehicle gear state other than the P position, and the values of the first local data, the fifth local data, and the sixth local data are maintained to be the same for the predetermined time period (e.g., 10 minutes) (S402).

The method may include transmitting the instruction to the vehicle integration controller mounted on the vehicle to operate the brakes of the vehicle in the first manner (S403) if the value of the first local data indicates the driver getting-on state, the value of the fifth local data is 0, the value of the sixth local data indicates the vehicle gear state other than the P position, and the values of the first local data, the fifth local data, and the sixth local data are determined to be maintained to be the same for the predetermined time period (e.g., 10 minutes) (Yes in S403). Else, the method may end and/or return to start.

For more detailed information on the method, descriptions of examples included in this specification may be referred to, and its redundant description is thus omitted.

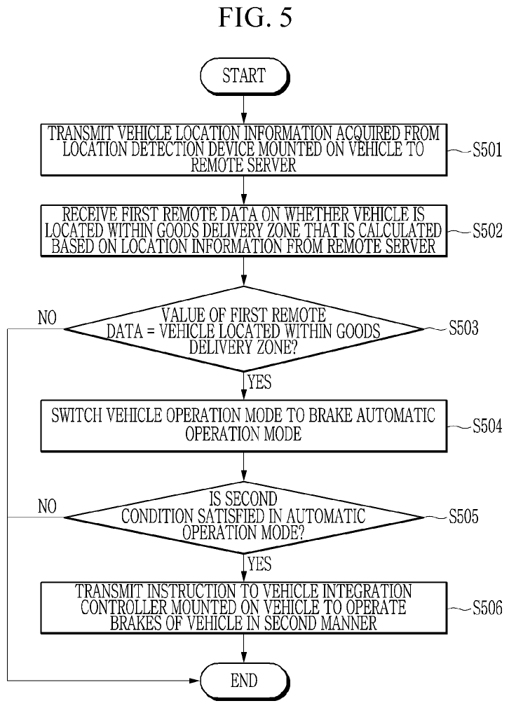

FIG. 5 is flowchart of a method for operating brakes of a vehicle according to an example.

Referring to FIG. 5, the method for operating brakes of a vehicle according to an example includes: transmitting the vehicle location information acquired from the location detection device mounted on the vehicle to the remote server (S501); receiving the first remote data indicating whether the vehicle is located within the goods delivery zone that is calculated based on the location information from the remote server (S502); and determining whether the value of the first remote data indicates that the vehicle is located within the goods delivery zone (S503).

The method may include switching/setting/maintaining the vehicle operation mode to/as the brake automatic operation mode (S504) if the value of the first remote data is determined to indicate that the vehicle is located within the goods delivery zone (Yes in S503); and determining whether the second condition is satisfied in the automatic operation mode (S505).

The method may include transmitting the instruction to the vehicle integration controller mounted on the vehicle to operate the brakes of the vehicle in the second manner (S506) if the automatic operation mode is determined to satisfy the second condition (Yes in S505).

If the vehicle is not located within the goods delivery zone (No in S503), the vehicle operation mode may be set/switched to/maintained as the normal operation mode (not the brake automatic operation mode), and the method may end and/or return to start. If the second condition is not satisfied (No in S505), the method may end and/or return to start.

For more detailed information on the method, descriptions of examples included in this specification may be referred to, and its redundant description is thus omitted.

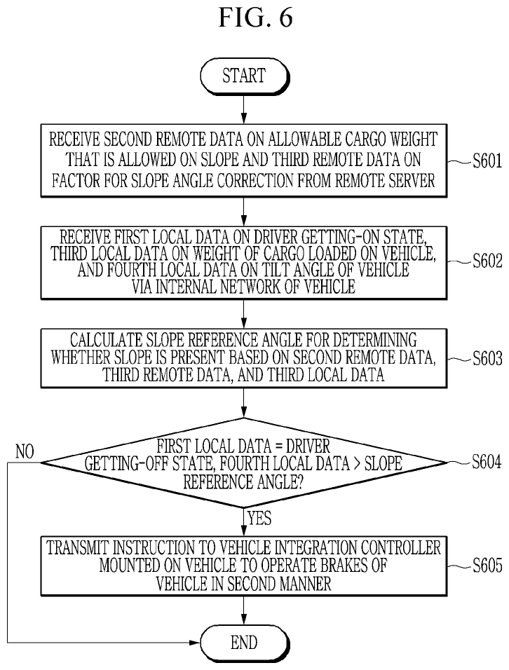

FIG. 6 is flowchart of a method for operating brakes of a vehicle according to an example.

Referring to FIG. 6, the method for operating brakes of a vehicle according to an example may include: receiving the second remote data indicating the allowable cargo weight that is allowed on the slope and the third remote data indicating the factor for the slope angle correction from the remote server (S601); receiving the first local data indicating the driver getting-on/off state, the third local data indicating the weight of the cargo loaded on the vehicle, and the fourth local data indicating the tilt angle of the vehicle via the internal network of the vehicle (S602); calculating the slope reference angle for determining whether the slope is present based on the second remote data, the third remote data, and the third local data (S603); and determining whether the value of the first local data indicates the driver getting-off state and the value of the fourth local data is greater than the slope reference angle (S604).

The method may include transmitting the instruction to the vehicle integration controller mounted on the vehicle to operate the brakes of the vehicle in the second manner (S605) if the value of the first local data indicates the driver getting-off state, and the value of the fourth local data is determined to be greater than the slope reference angle (Yes in S604). If the value of the first local data indicates the driver getting-off state, and the value of the fourth local data is determined to be less than or equal to than the slope reference angle (No in S604), the method may end and/or return to start.

For more detailed information on the method, descriptions of examples included in this specification may be referred to, and its redundant description is thus omitted.

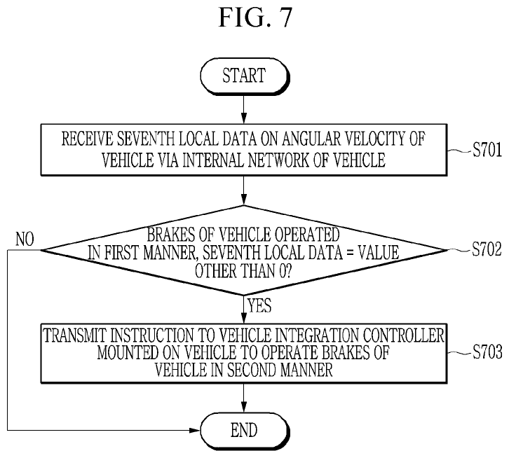

FIG. 7 is flowchart of a method for operating brakes of a vehicle according to an example.

Referring to FIG. 7, the method for operating brakes of a vehicle according to an example includes: receiving the seventh local data indicating the angular velocity of the vehicle via the internal network of the vehicle (S701); and determining whether the brakes of the vehicle are operated in the first manner and the value of the seventh local data is other than 0 (e.g., the vehicle is moving) (S702).

The method may include transmitting the instruction to the vehicle integration controller mounted on the vehicle to operate the brakes of the vehicle in the second manner (S703) if the brakes of the vehicle are operated in the first manner and the value of the seventh local data is determined to be other than 0 (Yes in S702). If the brakes of the vehicle are operated in the first manner and the value of the seventh local data is determined to be 0 (No in S702), the method may end and/or return to start.

For more detailed information on the method, descriptions of examples included in this specification may be referred to, and its redundant description is thus omitted.

FIG. 8 is a view for describing the computing device according to an example.

Referring to FIG. 8, the method and the device for operating brakes of a vehicle according to the examples may be implemented using the computing device 50. The computing device 50 may be implemented as any of diverse types of electronic devices, servers, or similar devices, and its function may be implemented through a combination of software and hardware.

The computing device 50 may include at least one of the processor 510, a memory 530, a user interface input device 540, a user interface output device 550, and a storage device 560, performing their communications with one another using a bus 520. The computing device 50 may also include a network interface 570 electrically connected to a network 40. The network interface 570 may transmit or receive a signal with another entity via the network 40.

The processor 510 may be implemented as any of various types of computing units, such as a micro controller unit (MCU), an application processor (AP), a central processing unit (CPU), a graphic processing unit (GPU), a neural processing unit (NPU), or a quantum processing unit (QPU). The processor 510 may also be a semiconductor device that executes an instruction stored in the memory 530 or the storage device 560 and may perform a core function of a system. A program code and data stored in the memory 530 or the storage device 560 may instruct the processor 510 to perform a specific task, thereby enabling overall operations of the system. In this way, the processor 510 may be configured to implement the various functions and methods described above with reference to FIGS. 1 to 7.

The memory 530 and the storage device 560 may include various types of volatile or non-volatile storage media for storing and accessing data in the system. For example, the memory 530 may include a read only memory (ROM) 531 and a random access memory (RAM) 532. In some examples, the memory 530 may be embedded in the processor 510, in which case data transmission between the memory 530 and the processor 510 may be performed at a fast speed. In some examples, the memory 530 may be disposed outside the processor 510, in which case the memory 530 may be connected to the processor 510 through various data buses or interfaces. This connection may be made by various configurations already known, for example, through a peripheral component interconnect express (PCIe) interface for the high-speed data transmission or through a memory controller.

In some examples, at least some components or functions of the method and the device for operating brakes of a vehicle according to the examples may be implemented as the program or software executed by the computing device 50, and the program or software may be stored in a computer-readable recording or storage medium. In detail, the computer-readable recording or storage medium according to an example may have a program recorded for executing steps included in the implementation of the method and the device for operating brakes of a vehicle according to the examples, recorded on a computer including the processor 510 executing the program or the instruction, stored in the memory 530 or the storage device 560.

In some examples, at least some components or functions of the method and the device for operating brakes of a vehicle according to the examples may be implemented using the hardware or circuitry of the computing device 50, or implemented using a separate hardware or circuitry that may be electrically connected to the computing device 50.

The present disclosure attempts to provide a method and a device for operating brakes of a vehicle that automatically operates brakes of a vehicle in consideration of a goods delivery situation.

According to an example, provided is a method for operating brakes of a vehicle that automatically operates the brakes of the vehicle in consideration of a goods delivery situation and performed by a computing device implemented in the vehicle and including a processor and a communication interface, the method including: transmitting, by the processor, vehicle location information acquired from a location detection device mounted on the vehicle to a remote server via the communication interface, receiving, by the processor, first remote data on whether the vehicle is located within a goods delivery zone that is calculated based on the location information from the remote server via the communication interface, switching, by the processor, a vehicle operation mode to a brake automatic operation mode if a value of the first remote data is determined to indicate that the vehicle is located within the goods delivery zone; determining, by the processor, whether a predetermined first condition is satisfied in the automatic operation mode; and transmitting, by the processor, an instruction to a vehicle integration controller mounted on the vehicle to operate the brakes of the vehicle in a first manner if the first condition is determined to be satisfied.

The method may further include: receiving, by the processor, second remote data on an allowable cargo weight that is allowed on a slope and third remote data on a factor for slope angle correction from the remote server via the communication interface; receiving, by the processor, first local data on a driver getting-on state, second local data on an open/close state of a door installed on a vehicle cargo, third local data on a weight of the cargo loaded on the vehicle, and fourth local data on a tilt angle of the vehicle via an internal network of the vehicle; and calculating, by the processor, a slope reference angle for determining whether the slope is present based on the second remote data, the third remote data, and the third local data, wherein the determining whether the predetermined first condition is satisfied may include, the first condition is determined, by the processor, to be satisfied if a value of the first local data indicates a driver getting-off state, a value of the second local data indicates the door open state, and a value of the fourth local data is the slope reference angle or less.

The calculating the slope reference angle may include, the slope reference angle may be calculated by the processor based on the following Equation:

$$A = S * M / m * a \qquad ( Equation )$$

Here, A indicates the slope reference angle, S indicates a predetermined slope standard angle, M indicates the allowable cargo weight that is allowed on the slope determined based on the second remote data, m indicates the weight of the cargo loaded on the vehicle that is determined based on the third local data, and a indicates the factor for the slope angle correction determined based on the third remote data.

The third remote data may have a lower value when a safety requirement to be achieved is higher, and a higher value when the safety requirement is lower.

The third remote data may have a different value depending on the weather in the goods delivery zone where the vehicle is located.

The method may further include receiving, by the processor, first local data on a driver getting-on state, fifth local data on a vehicle speed, and sixth local data on a vehicle gear state via an internal network of the vehicle, wherein the determining whether the predetermined first condition is satisfied may include, the first condition is determined, by the processor, to be satisfied if a value of the first local data indicates a driver getting-on state, a value of the fifth local data is 0, a value of the sixth local data indicates the vehicle gear state other than a P position, and the values of the first local data, the fifth local data, and the sixth local data are maintained to be the same for a predetermined time period.

The method may further include: determining, by the processor, whether a predetermined second condition is satisfied in the automatic operation mode; and transmitting, by the processor, an instruction to the vehicle integration controller to operate the brakes of the vehicle in a second manner different from the first manner if the second condition is determined to be satisfied.

The method may further include: receiving, by the processor, second remote data on an allowable cargo weight that is allowed on a slope, and third remote data on a factor for slope angle correction from the remote server via the communication interface; receiving, by the processor, first local data on a driver getting-on state, third local data on a weight of a cargo loaded on the vehicle, and fourth local data on a tilt angle of the vehicle via an internal network of the vehicle; and calculating, by the processor, a slope reference angle for determining whether the slope is present based on the second remote data, the third remote data, and the third local data, wherein the determining whether the predetermined second condition is satisfied may include, the second condition is determined, by the processor, to be satisfied if a value of the first local data indicates a driver getting-off state and a value of the fourth local data is greater than the slope reference angle.

The method may further include receiving, by the processor, seventh local data on an angular velocity of the vehicle via the internal network of the vehicle, wherein the determining whether the predetermined second condition is satisfied may include, the second condition is determined, by the processor, to be satisfied if the brakes of the vehicle are operated in the first manner and a value of the seventh local data is other than 0.

The vehicle location information and a map managed by the remote server, in which the goods delivery zone is designated, may be compared by the remote server, and the first remote data may be determined as a value indicating that the vehicle is located within the goods delivery zone if a vehicle location is determined to be within the goods delivery zone on the map.

According to an example, provided is a device for operating brakes of a vehicle that automatically operates the brakes of the vehicle in consideration of a goods delivery situation by executing an instruction loaded on at least one memory device through at least one processor implemented in the vehicle, wherein the instruction is executed to transmit vehicle location information acquired from a location detection device mounted on the vehicle to a remote server via a communication interface, receive first remote data on whether the vehicle is located within a goods delivery zone that is calculated based on the location information from the remote server via the communication interface, switch a vehicle operation mode to a brake automatic operation mode if a value of the first remote data is determined to indicate that the vehicle is located within the goods delivery zone, determine whether a predetermined first condition is satisfied in the automatic operation mode, and transmit the instruction to a vehicle integration controller mounted on the vehicle to operate the brakes of the vehicle in a first manner if the first condition is determined to be satisfied.

The instruction may be executed to further receive second remote data on an allowable cargo weight that is allowed on a slope and third remote data on a factor for slope angle correction from the remote server via the communication interface, receive first local data on a driver getting-on state, second local data on an open/close state of a door installed on a vehicle cargo, third local data on a weight of the cargo loaded on the vehicle, and fourth local data on a tilt angle of the vehicle via an internal network of the vehicle, calculate a slope reference angle for determining whether the slope is present based on the second remote data, the third remote data, and the third local data, and wherein the determining whether the predetermined first condition is satisfied may include, the first condition may be determined to be satisfied if a value of the first local data indicates a driver getting-off state, a value of the second local data indicates the door open state, and a value of the fourth local data is the slope reference angle or less.

The calculating the slope reference angle may include, the slope reference angle may be calculated based on the following Equation:

$$A = S * M / m * a \qquad ( Equation )$$

Here, A indicates the slope reference angle, S indicates a predetermined slope standard angle, M indicates the allowable cargo weight that is allowed on the slope determined based on the second remote data, m indicates the weight of the cargo loaded on the vehicle that is determined based on the third local data, and a indicates the factor for the slope angle correction determined based on the third remote data.

The third remote data may have a lower value when a safety requirement to be achieved is higher, and a higher value when the safety requirement is lower.

The third remote data may have a different value depending on the weather in the goods delivery zone where the vehicle is located.

The instruction may be executed to further receive first local data on a driver getting-on state, fifth local data on a vehicle speed, and sixth local data on a vehicle gear state via an internal network of the vehicle, and wherein the determining whether the predetermined first condition is satisfied may include, the first condition may be determined to be satisfied if a value of the first local data indicates a driver getting-on state, a value of the fifth local data is 0, a value of the sixth local data indicates the vehicle gear state other than a P position, and the values of the first local data, the fifth local data, and the sixth local data are maintained to be the same for a predetermined time period.

The instruction may be executed to further determine whether a predetermined second condition is satisfied in the automatic operation mode, and transmit the instruction to the vehicle integration controller to operate the brakes of the vehicle in a second manner different from the first manner if the second condition is determined to be satisfied.

The instruction may be executed to further receive second remote data on an allowable cargo weight that is allowed on a slope, and third remote data on a factor for slope angle correction from the remote server via the communication interface, receive first local data on a driver getting-on state, third local data on a weight of a cargo loaded on the vehicle, and fourth local data on a tilt angle of the vehicle via an internal network of the vehicle, calculate a slope reference angle for determining whether the slope is present based on the second remote data, the third remote data, and the third local data, and wherein the determining whether the predetermined second condition is satisfied may include, the second condition may be determined to be satisfied if a value of the first local data indicates a driver getting-off state and a value of the fourth local data is greater than the slope reference angle.

The instruction may be executed to further receive seventh local data on an angular velocity of the vehicle via the internal network of the vehicle, and wherein the determining whether the predetermined second condition is satisfied may include, the second condition may be determined to be satisfied if the brakes of the vehicle are operated in the first manner and a value of the seventh local data is other than 0.

According to an example, provided is a computer-readable recording medium recording an instruction executed by a computing device implemented in a vehicle and including a processor and a communication interface, wherein the instruction is executed by the computing device, thus causing the computing device to transmit vehicle location information acquired from a location detection device mounted on the vehicle to a remote server via a communication interface, receive first remote data on whether the vehicle is located within a goods delivery zone that is calculated based on the location information from the remote server via the communication interface, switch a vehicle operation mode to a brake automatic operation mode if a value of the first remote data is determined to indicate that the vehicle is located within the goods delivery zone, determine whether a predetermined first condition is satisfied in the automatic operation mode, and transmit the instruction to a vehicle integration controller mounted on the vehicle to operate the brakes of the vehicle in a first manner if the first condition is determined to be satisfied.

According to examples, the convenience of the driver work may be increased while effectively preventing the accidents that may occur during the delivery by identifying the vehicle location in real time and controlling the brake operation based on the specific situation when the vehicle stops in the goods delivery zone.

Although the examples of the present disclosure have been described in detail hereinabove, the scope of the present disclosure is not limited thereto. That is, various modifications and alterations made by those skilled in the art to which the present disclosure pertains by using a basic concept of the present disclosure as defined in the following claims also fall within the scope of the present disclosure.

What is claimed is:

1. A method for operating brakes of a vehicle and performed by a computing device, of the vehicle, comprising a processor and a communication interface, the method comprising:
transmitting, by the processor and via the communication interface to a remote server, vehicle location information acquired from a location sensor mounted on the vehicle, wherein the vehicle location information indicates a location of the vehicle;
receiving, by the processor from the remote server via the communication interface, first remote data indicating whether the vehicle is located within a goods delivery zone, wherein the first remote data is based on the vehicle location information;
setting, by the processor based on the first remote data indicating that the vehicle is located within the goods delivery zone, a vehicle operation mode to a brake automatic operation mode;
determining, by the processor, whether a first condition, for operating the brakes of the vehicle in the brake automatic operation mode, is satisfied; and
transmitting, by the processor based on the first condition being satisfied, an instruction to a vehicle integration controller mounted on the vehicle, wherein the instruction is configured to cause the vehicle integration controller to operate the brakes of the vehicle in a first manner that is associated with the brake automatic operation mode.

2. The method of claim 1, further comprising:
receiving, by the processor via the communication interface and from the remote server:
second remote data indicating an allowable cargo weight that is allowed on a slope, and
third remote data indicating a factor for slope angle correction;
receiving, by the processor from one or more sensors of the vehicle via an internal network of the vehicle:
first local data indicating one of a driver getting-on state or a driver getting-off state,
second local data indicating an open/close state of a door installed on a cargo of the vehicle,
third local data indicating a weight of the cargo loaded on the vehicle, and
fourth local data indicating a tilt angle of the vehicle; and
determining, by the processor based on the second remote data and the third remote data and the third local data, a slope reference angle for determining whether the slope is present,
wherein the determining whether the first condition is satisfied is based on:
a value of the first local data indicating the driver getting-off state,
a value of the second local data indicating the door open state, and
a value of the fourth local data indicating a slope angle being less than or equal to the slope reference angle.

3. The method of claim 2, wherein
the determining the slope reference angle comprises
calculating the slope reference angle based on the following Equation:
$$A = S * M / m * a \qquad ( Equation )$$
where, A indicates the slope reference angle, S indicates a slope standard angle, M indicates the allowable cargo weight that is allowed on the slope determined based on the second remote data, m indicates the weight of the cargo loaded on the vehicle that is determined based on the third local data, and a indicates the factor for the slope angle correction determined based on the third remote data.

4. The method of claim 2, wherein:
the third remote data has value indicating a lower factor for slope angle correction based on a higher safety requirement, or indicating a higher factor for slope angle correction based on a lower safety requirement.

5. The method of claim 2, wherein:
the third remote data has a value that is differently set based on weather in the goods delivery zone.

6. The method of claim 1, further comprising:
receiving, by the processor via an internal network of the vehicle:
first local data indicating one of a driver getting-on state or a driver getting-off state;
fifth local data indicating a vehicle speed of the vehicle; and
sixth local data indicating a vehicle gear state of the vehicle,
wherein the determining whether the first condition is satisfied comprises determining that a value of the first local data indicating the driver getting-on state, a value of the fifth local data being 0, a value of the sixth local data indicating the vehicle gear state other than a park gear remain constant for at least a predetermined period of time.

7. The method of claim 1, further comprising:
determining, by the processor based on the vehicle being in the brake automatic operation mode, whether a second condition is satisfied; and
transmitting, by the processor based on the second condition being satisfied, an instruction to the vehicle integration controller to operate the brakes of the vehicle in a second manner different from the first manner, wherein in the brake automatic operation mode, the processor is configured to generate an automatic brake control to activate the brakes without a driver of the vehicle being present in the vehicle.

8. The method of claim 7, further comprising:
receiving, by the processor from the remote server via the communication interface, second remote data indicating an allowable cargo weight associated with a slope, and third remote data indicating a factor for slope angle correction;
receiving, by the processor via an internal network of the vehicle:
first local data indicating one of a driver getting-on state or a driver getting-off state,
third local data indicating a weight of a cargo loaded on the vehicle, and
fourth local data indicating a tilt angle of the vehicle; and
determining, by the processor based on the second remote data, the third remote data, and the third local data, a slope reference angle for determining whether the slope is present,
wherein the determining whether the second condition is satisfied is based on a value of the first local data indicating the driver getting-off state and a value of the fourth local data being greater than the slope reference angle.

9. The method of claim 7, further comprising
receiving, by the processor via an internal network of the vehicle, seventh local data indicating an angular velocity of the vehicle,
wherein the determining whether the second condition is satisfied comprises determining, by the processor based on the brakes of the vehicle being operated in the first manner and a value of the seventh local data being other than 0, the second condition to be satisfied.

10. The method of claim 1, wherein the first remote data comprises a value indicating that the vehicle is located within the goods delivery zone, wherein the value is based on a comparison between the vehicle location information and location information of a map indicating the goods delivery zone on the map.

11. A device for operating brakes of a vehicle, the device comprising:
at least one processor;
a communication interface; and
a memory storing at least one instruction that, when executed by the at least one processor, causes the device to:
transmit, via the communication interface to a remote server, vehicle location information acquired from a location sensor mounted on the vehicle, wherein the vehicle location information indicates a location of the vehicle;
receive, from the remote server via the communication interface, first remote data indicating whether the vehicle is located within a goods delivery zone, wherein the first remote data is based on the vehicle location information;
set, based on the first remote data indicating that the vehicle is located within the goods delivery zone, a vehicle operation mode to a brake automatic operation mode;
determine whether a first condition, for operating the brakes of the vehicle in the automatic operation mode, is satisfied; and
transmit, based on the first condition being satisfied, a second instruction to a vehicle integration controller mounted on the vehicle, wherein the second instruction is configured to cause the vehicle integration controller to operate the brakes of the vehicle in a first manner associated with the brake automatic operation mode.

12. The device of claim 11, wherein the at least one instruction, when executed by the at least one processor, further causes the device to:
receive, via the communication interface and from the remote server:
second remote data indicating an allowable cargo weight that is allowed on a slope, and
third remote data indicating a factor for slope angle correction,
receive, from one or more sensors of the vehicle and via an internal network of the vehicle:
first local data indicating one of a driver getting-on state or a driver getting-off state;
second local data indicating an open/close state of a door installed on a cargo area of the vehicle;
third local data indicating a weight of cargo loaded on the vehicle, and
fourth local data indicating a tilt angle of the vehicle; and
determine, based on the second remote data and the third remote data and the third local data, a slope reference angle for determining whether the slope is present, and
wherein the determining whether the first condition is satisfied is based on:
a value of the first local data indicating the driver getting-off state;
a value of the second local data indicating the open state of the door, and
a value of the fourth local data indicating a slope angle being less than or equal to the slope reference angle.

13. The device of claim 12, wherein
the determining the slope reference angle comprises calculating the slope reference angle based on the following Equation:
$$A = S * M / m * a \qquad ( Equation )$$
where, A indicates the slope reference angle, S indicates a slope standard angle, M indicates the allowable cargo weight that is allowed on the slope determined based on the second remote data, m indicates the weight of the cargo loaded on the vehicle that is determined based on the third local data, and a indicates the factor for the slope angle correction determined based on the third remote data.

14. The device of claim 12, wherein:
the third remote data has value indicating a lower factor for slope angle correction based on a higher safety requirement, or indicating a higher factor for slope angle correction based on a lower safety requirement.

15. The device of claim 12, wherein:
the third remote data has a value that differently set based on weather in the goods delivery zone.

16. The device of claim 11, wherein the at least one instruction, when executed by the at least one processor, further causes the device to:
receive, via an internal network of the vehicle:
first local data indicating one of a driver getting-on state or a driver getting-off state;
fifth local data indicating a vehicle speed of the vehicle; and
sixth local data indicating a vehicle gear state of the vehicle; and
wherein the determining whether the first condition is satisfied comprises determining that a value of the first local data indicating the driver getting-on state, a value of the fifth local data being 0, a value of the sixth local data indicating the vehicle gear state other than a park gear remain constant for at least a predetermined period of time.

17. The device of claim 11, wherein the at least one instruction, when executed by the at least one processor, further causes the device to:
determine, based on the vehicle being in the brake automatic operation mode, whether a second condition is satisfied; and
transmit, based on the second condition being satisfied, an instruction to the vehicle integration controller to operate the brakes of the vehicle in a second manner different from the first manner, wherein in the brake automatic operation mode, the processor is configured to generate an automatic brake control to activate the brakes without a driver of the vehicle being present in the vehicle.

18. The device of claim 17, wherein the at least one instruction, when executed by the at least one processor, further causes the device to:
receive, from the remote server via the communication interface, second remote data indicating an allowable cargo weight associated with a slope, and third remote data indicating a factor for slope angle correction,
receive, via an internal network of the vehicle:
first local data indicating one of a driver getting-on state or a driver getting-off state;
third local data indicating a weight of a cargo loaded on the vehicle; and
fourth local data indicating a tilt angle of the vehicle; and
determine, based on the second remote data, the third remote data, and the third local data, a slope reference angle for determining whether the slope is present; and
wherein the determining whether the second condition is satisfied is based on a value of the first local data indicating the driver getting-off state and a value of the fourth local data being greater than the slope reference angle.

19. The device of claim 17, wherein the at least one instruction, when executed by the at least one processor, further causes the device to:
receive, via an internal network of the vehicle, seventh local data indicating an angular velocity of the vehicle; and
wherein the determining whether the second condition is satisfied is based on the brakes of the vehicle being operated in the first manner and a value of the seventh local data being other than 0.

20. A non-transitory computer-readable recording medium storing instructions that, when executed, cause a computing device implemented in a vehicle to:
transmit, via a communication interface of the computing device of the vehicle and to a remote sever, vehicle location information acquired from a location sensor mounted on the vehicle, wherein the vehicle location information indicates a location of the vehicle;
receive, from the remote sever via the communication interface, first remote data indicating whether the vehicle is located within a goods delivery zone, wherein first remote data zone is based on the vehicle location information;
set, based on the first remote data indicating that the vehicle is located within the goods delivery zone, a vehicle operation mode to a brake automatic operation mode;
determine whether a first condition, for operating brakes of the vehicle in the brake automatic operation mode, is satisfied; and
transmit, based on the first condition being satisfied, a second instruction to a vehicle integration controller mounted on the vehicle, wherein the second instruction is configured to cause the vehicle integration controller to operate the brakes of the vehicle in a first manner associated with the brake automatic operation mode.
